(19) United States
(12) Patent Application Publication
(10) Pub. No.: US 2013/0148994 A1
(43) Pub. Date: Jun. 13, 2013

(54) IMAGE FORMING APPARATUS

(71) Applicant: Shougo FUKAI, Tokyo (JP)

(72) Inventor: Shougo FUKAI, Tokyo (JP)

(21) Appl. No.: 13/691,910

(22) Filed: Dec. 3, 2012

(30) Foreign Application Priority Data
Dec. 9, 2011 (JP) 2011-269869

(51) Int. Cl. G03G 15/20

(52) U.S. Cl. CPC G03G 15/2039
USPC 399/67; 399/122

(57) ABSTRACT

An image forming apparatus includes: a transfer section adapted to transfer toner to a sheet, a fixing section adapted to fix the toner transferred by the transfer section to the sheet, a swing driving mechanism adapted to perform a swing operation to move the fixing section in a direction parallel to the plane of the sheet and perpendicular to a conveying direction of the sheet, and a controller adapted to control the driving of the swing driving mechanism to move the fixing section during the period when the sheet has not yet entered the fixing section, and cause the fixing section to move a plurality of times to thereby constitute one cycle of the swing operation of the fixing section. The controller changes the moving distance of the fixing section at a predetermined timing.

### CROSS REFERENCES TO RELATED APPLICATIONS

The present invention contains subject matter related to Japanese Patent Application JP 2011-269869 filed in the Japanese Patent Office on Dec. 9, 2011, the entire contents of which being incorporated herein by reference.

### BACKGROUND OF THE INVENTION

1. Field of the Invention

The present invention relates to an image forming apparatus adapted to transfer a toner image to a sheet, and then fix the toner image to the sheet with a fixing section.

2. Description of the Related Art

Conventionally, there has been known an image forming apparatus that uses toner to form an image on a sheet. In such an image forming apparatus, a photoreceptor is electrically-charged and then the electrical charges are erased according to a document image, so that an electrostatic latent image is formed on the photoreceptor. Thereafter, a developing section is used to cause the toner to adhere to the electrostatic latent image of the photoreceptor so as to form a toner image.

Next, the toner image formed on the photoreceptor is transferred to the sheet. Alternatively, the toner image formed on the photoreceptor may be primarily transferred to an intermediate transfer body, and then the toner image on the intermediate transfer body is secondarily transferred to the sheet. Thereafter, the sheet is pressed and heated by a fixing section, so that the toner image is fixed to the sheet.

The fixing section has an upper fixing member and a lower fixing member, wherein the upper fixing member and the lower fixing member are brought into pressure contact with each other. For example, a roller, a belt and/or the like are used as the upper fixing member and the lower fixing member. The sheet is pressed and heated when it passes through between the upper and lower fixing members. With such a fixing section, every time the edge of the sheet passes through the same portion of the upper and lower fixing members, damage will be caused to the portion of the upper and lower fixing members contacted by the edge of the sheet.

In order to prevent the damage to the portion contacted by the edge of the sheet, an image forming apparatus has been proposed which has a swing driving mechanism adapted to swing the fixing section in a direction parallel to the plane of the sheet and perpendicular to the conveying direction of the sheet (see “Japanese Unexamined Patent Application Publication No. 2004-317843” and “Japanese Unexamined Patent Application Publication No. 2004-287317”).

There are two methods to swing the fixing section. One is the method of constantly swinging the fixing section, and the other is the method of moving the fixing section by a predetermined moving distance before the sheet enters the fixing section. In the method of constantly swinging the fixing section, the position where the sheet enters between the upper and lower fixing members is different from the position where the sheet exits between the upper and lower fixing members. Thus, the attitude of the sheet passing through the fixing section changes, which makes it difficult to control the position of the sheet. Further, in the case where the sheet is loaded on a sheet receiving tray, the sheets loaded on the sheet receiving tray will be deviated little by little.

On the other hand, in the method of moving the fixing section by a predetermined moving distance before the sheet enters the fixing section, since the fixing section is not moved (swung) while the sheet is passing through between the upper and lower fixing members, the attitude of the sheet does not change. Thus, with the method of moving the fixing section by a predetermined moving distance before the sheet enters the fixing section, it is easy to control the position of the sheet compared with the method of constantly swinging the fixing section.

### SUMMARY OF THE INVENTION

However, with the method of moving the fixing section by a predetermined moving distance before the sheet enters the fixing section, during the swing operation of the fixing section, the edge of the sheet will periodically pass through a predetermined portion of the upper and lower fixing members. This phenomenon appears because the fixing section is moved by a predetermined moving distance. For example, in the forward route of the swing operation of the fixing section, the edge of the sheet will always contact the predetermined portion of the upper and lower fixing members.

Particularly, when the image is formed on a large number of sheets of the same size, since the frequency of the swing operation is large, the frequency for the edge of the sheet to pass through the predetermined portion of the upper and lower fixing members will be large. As a result, it is more likely to cause damage to the predetermined portion of the upper and lower fixing members contacted by the edge of the sheet.

In an image forming apparatus having a resist mechanism for adjusting the position of the sheet before the toner image is transferred to the sheet, the position of the sheet to be conveyed to the fixing section is accurately adjusted. Thus, in the swing operation of the fixing section, the edge of the sheet accurately passes through the predetermined portion of the upper and lower fixing members. As a result, the damage caused to the predetermined portion of the upper and lower fixing members will be more serious.

In view of the problems of the prior arts, it is an object of the present invention to provide an image forming apparatus capable of reducing the damage to the fixing section caused by the edge of the sheet.

To solve the aforesaid problems and achieve the object of the present invention, an image forming apparatus according to an aspect of the present invention includes a transfer section, a fixing section, a swing driving mechanism and a controller.

The transfer section is adapted to transfer toner to a sheet, and the fixing section is adapted to fix the toner transferred by the transfer section to the sheet.

The swing driving mechanism is adapted to perform a swing operation to move the fixing section in a direction parallel to the plane of the sheet and perpendicular to a conveying direction of the sheet.

The controller is adapted to control the driving of the swing driving mechanism to move the fixing section during the period when the sheet has not yet entered the fixing section, and cause the fixing section to move a plurality of times to thereby constitute one cycle of the swing operation of the fixing section. The controller changes the moving distance of the fixing section at a predetermined timing.

In the image forming apparatus according to the aforesaid aspect of the present invention, the fixing section is moved by the swing driving mechanism in a direction parallel to the plane of the sheet and perpendicular to the conveying direction of the sheet during the period when the sheet has not yet entered the fixing section. Thus, it is easy to control the position of the sheet compared with the case where the fixing section is constantly moved to perform swing operation.

Further, since the controller changes the moving distance of the fixing section at a predetermined timing, the edge of the sheet passes through a position deviated from the predetermined portion of the fixing section. Thus, the frequency for the edge of the sheet to pass through the predetermined portion of the fixing section becomes low, and therefore the damage to the fixing section caused by the edge of the sheet can be reduced. As a result, the durability of the fixing section can be improved. Further, the quality of the image formed on the sheet can be improved.

Further, even if the space assigned for enabling the fixing section to contact the edge of the sheet is reduced, the durability of the fixing section can be maintained. As a result, the swinging distance of the fixing section can be reduced, and therefore the size of the apparatus can be reduced.

### BRIEF DESCRIPTION OF THE DRAWINGS

FIG. 1 is a view showing the overall configuration of an image forming apparatus according to a first embodiment of the present invention;

FIG. 2 is a view showing a fixing section and a swinging mechanism of the image forming apparatus according to the first embodiment;

FIG. 3 is a block diagram showing a control, system of the image forming apparatus according to the first embodiment;

FIG. 4 is a flowchart showing an example of swing operation processing of the image forming apparatus according to the first embodiment;

FIG. 5 is a view showing the contact portion between the edge of a sheet and the fixing section in the case where the fixing section of the image forming apparatus of the first embodiment is in a first reciprocating movement of the swing operation;

FIG. 6 is a view showing the contact portion between the edge of the sheet and the fixing section in the case where the fixing section of the image forming apparatus of the first embodiment is in a second reciprocating movement of the swing operation;

FIG. 7 is a flowchart showing an example of the swing operation processing of an image forming apparatus according to a second embodiment of the present invention;

FIG. 8 is a view showing the contact portion between the edge of the sheet and the fixing section in the case where the fixing section of the image forming apparatus of the second embodiment is in a second reciprocating movement of the swing operation; and

FIG. 9 is a block diagram showing a control system of an image forming apparatus according to a third embodiment of the present invention.

### DETAILED DESCRIPTION OF THE PREFERRED EMBODIMENTS

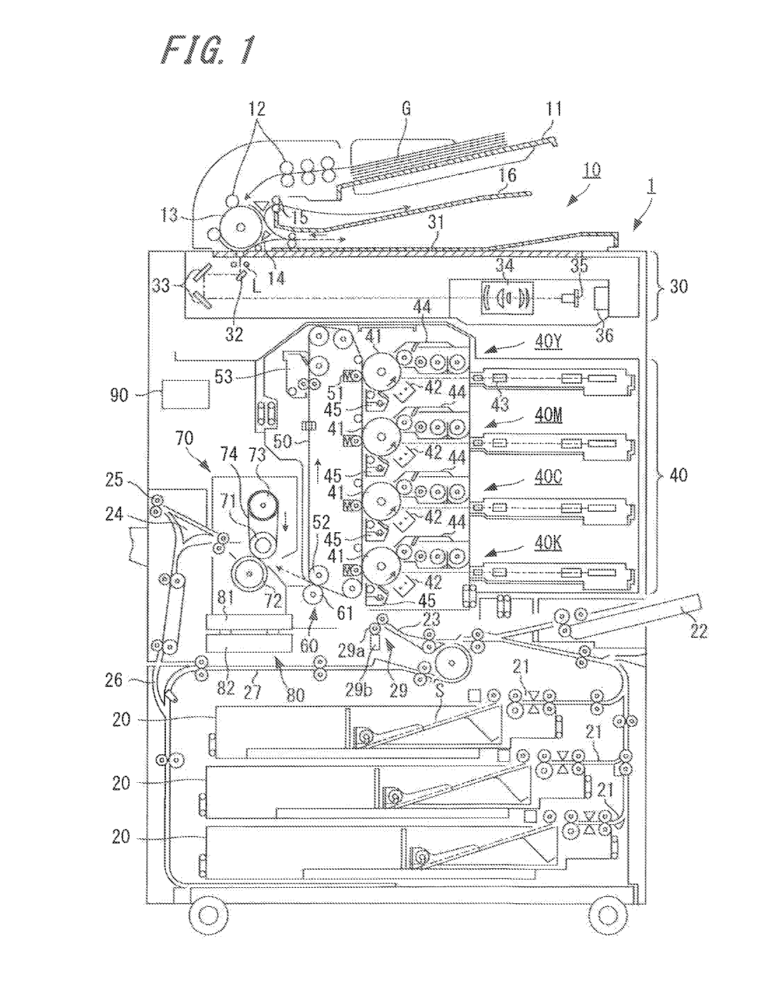

Next, image forming apparatuses according to the preferred embodiments of the present invention will be described below with reference to FIGS. 1 to 9.

Note that, in FIGS. 1 to 9, like components are denoted by like reference numerals.

The description will be given in the following order.
1. Image forming apparatus according to first embodiment
2. Image forming apparatus according to second embodiment
3. Image forming apparatus according to third embodiment
4. Modifications

### 1. Image Forming Apparatus According to First Embodiment

### [Configuration Example of Image Forming Apparatus]

First, a configuration example of an image forming apparatus according to a first embodiment of the present invention will be described below with reference to FIG. 1.

FIG. 1 is a view showing the overall configuration of an image forming apparatus 1 according to the first embodiment.

As shown in FIG. 1, the image forming apparatus 1 is adapted to form an image on a sheet based on electrophotographic technology. The image forming apparatus 1 is a tandem type color image forming apparatus, in which four colors of toner, which are yellow (Y), magenta (M), cyan (C), and black (Bk), are superimposed one on top of another. The image forming apparatus 1 includes a document conveying section 10, a plurality of sheet accommodating sections 20, an image reading section 30, an image forming section 40, an intermediate transfer belt 50, a secondary transfer section 60, a fixing section 70, a swing driving mechanism 80, and a control board 90.

The document conveying section 10 includes a document feeding table 11 for setting a document G, a plurality of rollers 12, a conveying drum 13, a conveying guide 14, a document ejecting roller 15, and a document receiving tray 16. The document G set on the document feeding table 11 is conveyed page by page to a reading position of the image reading section 30 by the plurality of rollers 12 and the conveying drum 13. The conveying guide 14 and the document ejecting roller 15 eject the document G conveyed by the plurality of rollers 12 and the conveying drum 13 to the document receiving tray 16.

The image reading section 30 reads the image of the document G conveyed by the document conveying section 10 or the image of a document placed on a platen 31, and creates image data. To be specific, the image of the document G is irradiated by a lamp L. The light reflected from the document G is guided to a first mirror unit 32, a second mirror unit 33 and a lens unit 34 in that order, so as to form an image on a light receiving surface of an image pickup device 35. The image pickup device 35 photoelectrically converts the light incident thereon and outputs a prescribed image signal. The image signal outputted by the image pickup device 35 is A/D converted to thereby create image data.

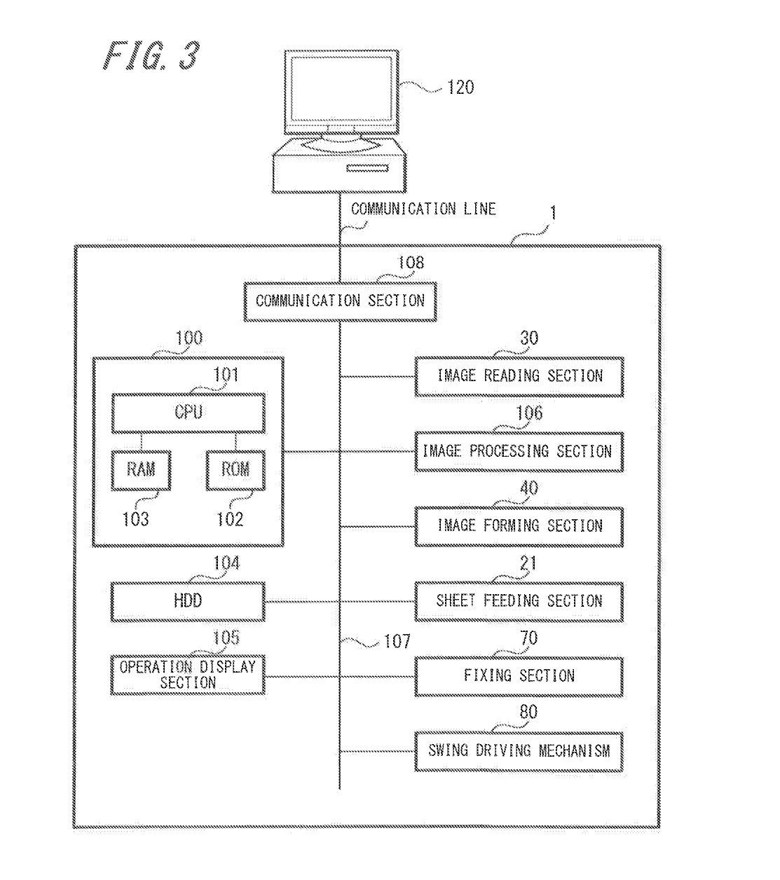

The image reading section 30 has an image reading control section 36. The image reading control section 36 performs various processing, such as shading correction, dither processing, compression and/or the like, on the image data created by the A/D conversion, and stores the resultant data in a RAM 103 of a controller 100 (see FIG. 3), which is to be described later. Incidentally, the image data is not limited to the data outputted from the image reading section 30, but may be data received from an external device (such as a personal computer, another image forming apparatus or the like) connected to the image forming apparatus 1.

The plurality of sheet accommodating sections 20 are arranged in the lower portion of the main body of the apparatus, and the number of the sheet accommodating sections 20 is determined according to the sizes and/or kinds of sheets S. The sheet S is fed by the sheet feeding section 21 and conveyed to the conveying section 23, and is then conveyed to the secondary transfer section 60 (which is the transfer position) by the conveying section 23. Further, a manual sheet feeding section 22 is arranged in the vicinity of the sheet accommodating sections 20. A specialty sheet, such as a sheet of a size not accommodated in the sheet accommodation section 20, a tag sheet having a tag, an OHP sheet or the like, is sent to the transfer position from the manual sheet feeding section 22.

The image forming section 40 and the intermediate transfer belt 50 are arranged between the image reading section 30 and the sheet accommodating section 20. The image forming section 40 has four image forming units 40Y, 40M, 40C, 40K for forming a toner image of yellow (Y), a toner image of magenta (M), a toner image of cyan (C), and a toner image of black (K).

To be specific, the first image forming unit 40Y forms a toner image of yellow, the second image forming unit 40M forms a toner image of magenta, the third image forming unit 40C forms a toner image of cyan, and the fourth image forming unit 40K forms a toner image of black. Since the four image forming units 40Y, 40M, 40C, 40K have the same configuration, only the first image forming unit 40Y will be described herein.

The first image forming unit 40Y has a drum-like photoreceptor 41, a charging section 42 arranged around the photoreceptor 41, an exposure section 43, a developing section 44, and a cleaning section 45. The photoreceptor 41 is rotated by a drive motor (not shown). The charging section 42 applies electric charges to the photoreceptor 41 so that the surface of the photoreceptor 41 is evenly charged. The exposure section 43 performs an exposure operation on the surface of the photoreceptor 41 based on the image data read from the document G or the image data transmitted from the external device, to thereby form an electrostatic latent image on the photoreceptor 41.

The developing section 44 causes yellow toner to adhere to the electrostatic latent image formed on the photoreceptor 41. Thus, a toner image of yellow is formed on the surface of the photoreceptor 41. Incidentally, the developing section 44 of the second image forming unit 40M causes the magenta toner to adhere to the photoreceptor 41 of the second image forming unit 40M, the developing section 44 of the third image forming unit 40C causes the cyan toner to adhere to the photoreceptor 41 of the third image forming unit 40C, and the developing section 44 of the fourth image forming unit 40K causes the black toner to adhere to the photoreceptor 41 of the fourth image forming unit 40K.

The cleaning section 45 removes the toner remaining on the surface of the photoreceptor 41.

The toner adhering to the photoreceptor 41 is transferred to the intermediate transfer belt 50 (which is an example of the intermediate transfer body). The intermediate transfer belt 50 is an endless belt wrapped around a plurality of rollers. The intermediate transfer belt 50 is driven by a drive motor (not shown) to rotate in a direction opposite to the rotation (moving) direction of the photoreceptor 41.

In the intermediate transfer belt 50, four primary transfer sections 51 are arranged in positions facing the respective photoreceptors 41 of the four image forming units 40Y, 40M, 40C, 40K. Each primary transfer section 51 applies a voltage having a polarity opposite to that of toner to the intermediate transfer belt 50, to thereby transfer the toner adhering on the photoreceptor 41 to the intermediate transfer belt 50.

Thus, by rotationally driving the intermediate transfer belt 50, four toner images respectively formed by the four image forming units 40Y, 40M, 40C, 40K are sequentially transferred to the surface of intermediate transfer belt 50. Consequently, a toner image of yellow, a toner image of magenta, a toner image of cyan, and a toner image of black are superimposed on the intermediate transfer belt 50 to thereby form a color image.

Further, a belt cleaning device 53 faces the intermediate transfer belt 50. The belt cleaning device 53 cleans the surface of the intermediate transfer belt 50 that has finished transferring the toner image to the sheet S.

A secondary transfer section 60 is arranged near the intermediate transfer belt 50 and on the downstream side of the conveying section 23 in the sheet conveying direction. The secondary transfer section 60 causes the sheet S conveyed by the conveying section 23 to contact the intermediate transfer belt 50, so that the toner image formed on the outer surface of the intermediate transfer belt 50 is transferred to the sheet S.

The secondary transfer section 60 has a secondary transfer roller 61. The secondary transfer roller 61 is brought into pressure contact with a secondary transfer facing roller 52. The nip portion where the secondary transfer roller 61 and the intermediate transfer belt 50 come into contact with each other works is the transfer position for transferring the toner image formed on the outer surface of the intermediate transfer belt 50 to the sheet S.

A resist mechanism 29 is arranged on the upstream side of the secondary transfer section 60 in the conveying direction of the sheet S. The resist mechanism 29 has a resist roller pair 29a and a roller moving section 29b, wherein the roller moving section 29b is adapted to move the resist roller pair 29a in a direction parallel to the plane of the sheet S and perpendicular to the conveying direction of the sheet S. The resist roller pair 29a is rotatably supported by a shaft extending in the direction parallel to the plane of the sheet S and perpendicular to the conveying direction of the sheet S.

The roller moving section 29b moves the shaft in an axial direction, so that the resist roller pair 29a is moved along with the shaft in the direction parallel to the plane of the sheet S and perpendicular to the conveying direction of the sheet S. When the resist roller pair 29a moves, the sheet S will move along with the resist roller pair 29a in the direction parallel to the plane of the sheet S and perpendicular to the conveying direction of the sheet S. Further, when a sensor (not shown) has detected an edge of the sheet S parallel to the conveying direction, the roller moving section 29b will stop moving the resist roller pair 29a. Thus, the position of the edge of the sheet S parallel to the conveying direction is aligned. For example, when forming images on both sides of the sheet S, the positions where the images are to be formed on both surfaces of the sheet S can be aligned.

The fixing section 70 is arranged on the sheet S ejection side of the secondary transfer section 60. The fixing section 70 presses and heats the sheet S to fix the transferred toner image to the sheet S. The fixing section 70 includes, for example, an upper fixing roller 71, a lower fixing roller 72, a heating roller 73, and a fixing belt 74.

The intermediate transfer belt 74 is an endless belt wrapped around the heating roller 73 and the upper fixing roller 71. The heating roller 73 heats the fixing belt 74. The upper fixing roller 71 and the lower fixing roller 72 are arranged in a state where they are brought into pressure contact with each other through the fixing belt 74, so that a fixing nip portion is formed as a pressure-contact portion between the upper fixing roller 71 and the lower fixing roller 72. The heat of the fixing belt 74 is transferred to the sheet S, and thereby the toner image on the sheet S is heat-fixed.

The sheet S is conveyed so that the surface having the toner image transferred thereto by the secondary transfer section 60 (i.e., the surface to be subjected to heat-fixing) faces the upper fixing roller 71, and passes through the fixing nip portion. Thus, the sheet S passing through the fixing nip portion is pressed by the upper fixing roller 71 and the lower fixing roller 72, and heated by the fixing belt 74.

The swing driving mechanism 80 is arranged below the fixing section 70. The swing driving mechanism 80 swings the fixing section 70 in the direction parallel to the plane of the sheet S and perpendicular to the conveying direction of the sheet S. The swing driving mechanism 80 will be described later in more detail.

A switching gate 24 is arranged on the downstream side of the fixing section 70 in the conveying direction of the sheet S. The switching gate 24 switches the conveying path of the sheet S passed through the fixing section 70. In other words, when ejecting sheet with the image side facing up in the case of forming image on one side of the sheet, the switching gate 24 will cause the sheet S to go straight ahead. Therefore, the sheet S is ejected by a pair of sheet ejecting rollers 25. Further, when ejecting sheet with the image side facing down in the case of forming image on one side of the sheet, or when forming images on both sides of the sheet, the switching gate 24 will guide the sheet 3 downward.

Further, when ejecting sheet with the image side facing down, after the sheet S has been guided downward by the switching gate 24, the sheet S will be reversed and conveyed upward by a sheet reversing and conveying section 26. Therefore, the reversed sheet S is ejected by the pair of sheet ejecting rollers 25.

When forming images on both sides of the sheet, after the sheet S has been guided downward by the switching gate 24, the sheet S will be reversed by the sheet reversing and conveying section 26 and sent to the transfer position again by a sheet re-feeding path 27.

Alternatively, a post-processing device may be arranged on the downstream side of the pair of the sheet ejecting rollers 25, wherein the post-processing device is adapted to perform folding processing, stapling processing and the like on the sheet S.

### [Swing Driving Mechanism]

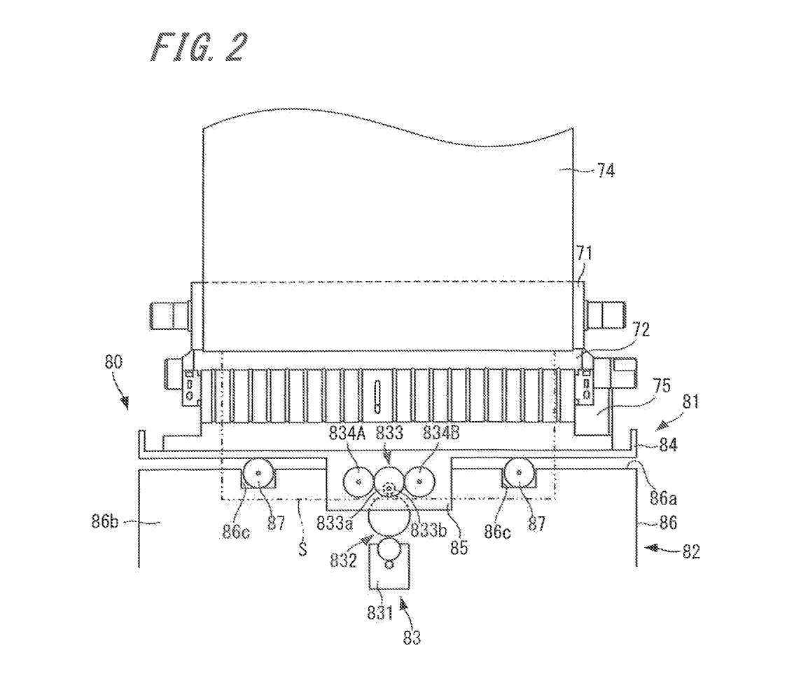

Next, the swing driving mechanism 80 will be described below with reference to FIG. 2.

FIG. 2 is a view showing the swing driving mechanism 80.

The swing driving mechanism 80 includes a holding table 81 for holding the fixing section 70, a supporting table 82 for supporting the holding table 81 so that the holding table 81 can swing, and a drive section 83 for causing the holding table 81 to swing on the supporting table 82.

The holding table 81 has a base portion 84 and a roller mounting portion 85, wherein the roller mounting portion 85 protrudes from the base portion 34. The base portion 84 faces an upper surface 86a (which is to be described later) of the supporting table 82. A roller supporting portion 75 of the fixing section 70 is fixed to the base portion 84. The roller supporting portion 75 rotatably supports the upper fixing roller 71, the lower fixing roller 72 and the heating roller 73 (see FIG. 1).

The roller mounting portion 85 of the holding table 81 protrudes from the lower portion of the base portion 84, and faces a wall surface 86b (which is to be described later) of the supporting table 82. A pair of engaging roller 834A, 834B (which are to be described later) of the drive section 83 are rotatably mounted on the roller mounting portion 85.

The supporting table 82 includes a main body 86 and a plurality of rotating bodies 87, wherein the plurality of rotating bodies 87 are rotatably supported by the main body 86. The main body 86 has the upper surface 86a and the wall surface 86b (which have been mentioned above), wherein the upper surface 86a faces the base portion 84 of the holding table 81, and the wall surface 86b faces the roller mounting portion 85 of the holding table 81. The upper surface 86a of the main body 86 is formed with a plurality of recessed portions 86c to rotatably house the plurality of rotating bodies 87. The depth of each of the recessed portions 86c is set to be smaller than the diameter of each of the rotating bodies 87, so that a portion of each rotating body 87 protrudes from the upper surface 86a.

The plurality of rotating bodies 87 each rotate around a shaft extending in a direction perpendicular to the wall surface 86b of the main body 86. The base portion 84 of the holding table 81 is placed on the plurality of rotating bodies 87. Thus, the holding table 81 is supported by the supporting table 82 so as to be able to move in a direction parallel to the plane of the sheet S and perpendicular to the conveying direction of the sheet S. By placing the base portion 84 of the holding table 81 on the plurality of rotating bodies 87, the frictional resistance generated between the holding table 81 and the supporting table 82 can be reduced, and therefore the driving force of the drive section 83 can be reduced.

The drive section 83 includes a stepping motor 831, a reduction gear group 832, an eccentric cam 833, a pair of engaging rollers 834A, 834B. The rotation shaft of the stepping motor 831 meshes with a gear of the reduction gear group 832 located at one end. A gear of the reduction gear group 832 located at the other end meshes with a gear portion 833b (which is to be described later) of the eccentric cam 833.

The eccentric cam 833 has a disk-like cam portion 833a and the gear portion 833b provided on the rotation shaft of the cam portion 833a. The cam portion 833a is mounted on roller mounting portion 85 of the holding table 81, and the rotation shaft of the cam portion 833a is inserted through an opening (not shown) formed in the roller mounting portion 85 and rotatably mounted on the main body 86 of the supporting table 82. The gear portion 833b is arranged between the roller mounting portion 85 and the main body 86 of the supporting table 82, and meshes with the gear of the reduction gear group 832 located on the other end.

The pair of engaging rollers 834A, 834B are rotatably mounted on the roller mounting portion 85 of the holding table 81 with the cam portion 833a of the eccentric cam 833 interposed therebetween. The periphery of the pair of engaging rollers 834A, 834B is brought into line contact with the periphery of the cam portion 833a of the eccentric cam 833.

When the rotation shaft of the stepping motor 631 rotates, the rotation force of the stepping motor 831 will be transmitted to the gear portion 833b of the eccentric cam 833 through the reduction gear group 832. Thus, the eccentric cam 833 will rotate with the rotation shaft as the rotation center. As a result, the cam portion 833a of the eccentric cam 833 is displaced to press one of the pair of engaging rollers 834A, 834B, so that the holding table 81 moves in the direction parallel to the plans of the sheet S and perpendicular to the conveying direction of the sheet S. When the cam portion 833a of the eccentric cam 833 rotates one turn, the holding table 81 will complete one cycle (one reciprocating movement) of the swing operation and return to the original position.

### [Hardware Configuration of Each Section of Image Forming Apparatus]

Next, hardware configuration of each section of the image forming apparatus 1 will be described below with reference to FIG. 3.

FIG. 3 is a block diagram shown a control system of the image forming apparatus 1.

As shown in FIG. 3, the image forming apparatus 1 includes a controller 100. The controller 100 is configured on the control board 30 (see FIG. 1), which has been mentioned above.

The controller 100 includes, for example, a CPU (central processing unit) 101, a ROM (Read Only Memory) 102 for storing program(s) executed by the CPU 101 and the like, and a RAM (Random Access Memory) 103 used as work area of the CPU 101. Incidentally, typically an electrically erasable programmable ROM, for example, is used as the ROM 102.

The CPU 101 controls the whole image forming apparatus. The CPU 101 is connected to both a HDD 104 and an operation display section 105 through a system bus 107. Further, the CPU 101 is connected to a communication section 108, the image reading section 30, an image processing section 106, the image forming section 40, the sheet feeding section 21, the fixing section 70, and the swing driving mechanism 80 through the system bus 107.

The HDD 104 is adapted to store the image data of the image of the document read by the image reading section 30, the image data having been outputted, and the like. The operation display section 105 is a touch panel configured by a display such as a liquid crystal display (LCD), an organic ELD (electro luminescent display), or the like. The operation display section 105 is adapted to display an instruction menu for the user, information associated with acquired image data, and the like. Further, the operation display section 105 has a plurality of keys, and is adapted to receive input of data inputted by the user by operating the keys and output an input signal, wherein the data inputted by the user includes various instructions, characters, numbers and the like.

The communication section 108 is adapted to receive, through a communication line, job information sent from a PC (personal computer) 120, which is the external device. The received job information is transmitted to the controller 100 through the system bus 107. In the job information, the image data of the image to be formed, the information of the sheet to be used associated with the image data, and the like are set.

Incidentally, although the present embodiment is described based on an example in which a personal computer is used as the external device, the present invention is not limited to such example, but various other devices, such as a facsimile device or the like, can be used as the external device.

The image reading section 30 optically reads the image of the document and converts the image into an electrical signal. For example, when reading a color document, the image reading section 30 generates image data having brightness information of 10 bits per pixel for each RGB. The image data generated by the image reading section 30 or the image data transmitted from the PC 120 (which is an example of the external device connected to the image forming apparatus 1) is sent to the image processing section 106 to be subjected to image processing. The image processing section 106 performs various processing, such as analog processing, AD conversion, shading correction, image compression and the like, on the received image data.

For example, when color printing is performed by using the image forming apparatus 1, the image data of R, G, B generated by the image reading section 30 and the like is inputted to a color conversion LUT (look-up table) in the image processing section 106. The image processing section 106 color-converts the R, G, B data into Y, M, C, K image data. Further, the image processing section 106 performs various processing on the image data having been subjected to the color-conversion, wherein the various processing includes: correction of tone reproduction characteristic, screen processing of halftone dots with reference to the density correction LUT, edge processing for emphasizing fine lines, and the like.

The image forming section 40 is drive-controlled by the controller 100 to form a toner image on the sheet S. The fixing section 70 is drive-controlled by the controller 100 to press and heat the sheet S, so that the toner image is fixed on the sheet S. The swing driving mechanism 80 is drive-controlled by the controller 100 to cause the fixing section 70 to perform swing operation.

The controller 100 controls the driving of the swing driving mechanism 80 to move the fixing section 70 toward one side in the swing direction during the period when the sheet S has not yet entered the fixing section 70. When a predetermined number of sheets S have passed through the fixing section 70, the fixing section 70 completes one cycle (i.e., one reciprocating movement) of the swing operation. In other words, the controller 100 causes the fixing section 70 to move a plurality of times to thereby constitute one cycle of the swing operation of the fixing section 70.

### [Swing Operation Processing of Fixing Section]

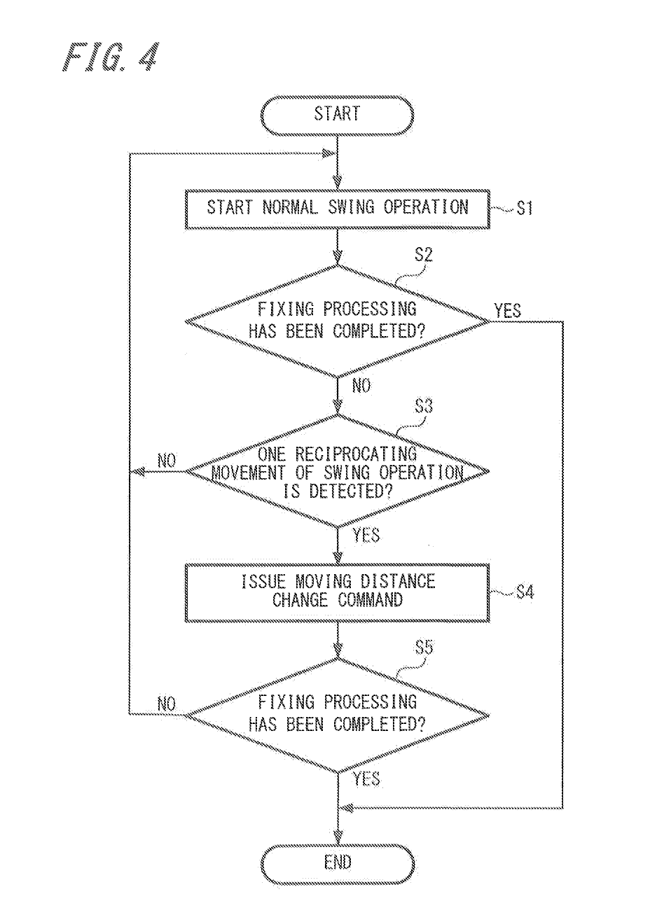

Next, swing operation processing performed by the CPU 101 will be described below with reference to FIGS. 4 to 6.

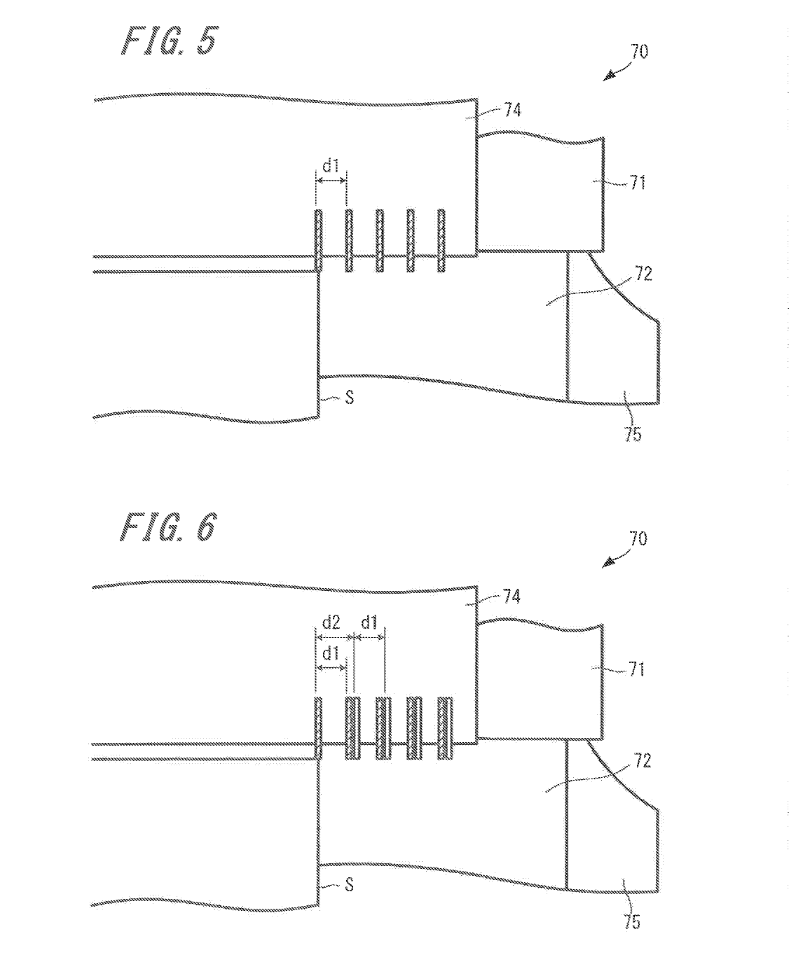

FIG. 4 is a flowchart showing an example of the swing operation processing. FIG. 5 is a view showing the contact portion between an edge of the sheet S and the fixing section 70 in the case where the fixing section 70 is in the first reciprocating movement of the swing operation. FIG. 6 is a view showing the contact portion between the edge of the sheet S and the fixing section 70 in the case where the fixing section 70 is in the second reciprocating movement of the swing operation.

The swing operation processing is started based on the start of the operation of forming image on the sheet S performed by the image forming section 40. As shown in FIG. 4, when the swing operation processing is started, first, the controller 100 starts a normal swing operation (step S1). In the normal swing operation, the fixing section 70 is moved by a preset normal moving distance d1 during the period when the sheet S has not yet entered the fixing section 70. The expression “the period when the sheet S has not yet entered the fixing section 70” means a period from the time when one sheet S has passed through the fixing nip portion of the fixing section 70 to the time when the next sheet S enters the fixing nip portion of the fixing section 70.

When the processing of step S1 has been performed, the contact portion between the edge of the sheet S and the lower fixing roller 72 and fixing belt 74 of the fixing section 70 will be displaced at an interval of the normal moving distance d1 (see FIG. 5).

Thereafter, the controller 100 determines whether or not the fixing processing has been completed (step S2). If it is determined that the fixing processing has been completed, the controller 100 will terminate the swing operation processing.

In the processing of step S2, if it is determined that the fixing processing has not been completed, the controller 100 will determine whether the fixing section 70 has completed one reciprocating movement of the swing operation (step S3). In the present embodiment, an optical sensor is used to detect the fact that the fixing section 70 has completed one reciprocating movement of the swing operation. The fact that the fixing section 70 has completed one reciprocating movement of the swing operation may also be detected by other sensors such as a magnetic sensor, or be detected by causing the fixing section 70 to press a physical switch.

In the processing of step S3, if it is determined that the fixing section 70 has not completed one reciprocating movement of the swing operation, the controller 100 will move the process to step S1. In other words, the normal swing operation will continue until the fixing section 70 has completed one reciprocating movement of the swing operation. In the present embodiment, when the fixing section 70 reverses its moving direction so as to move along the return route of the swing operation, the edge of the sheet S passing through the fixing section 70 will contact again the same portion where the edge of the sheet S contacted the lower fixing roller 72 and fixing belt 74 of the fixing section 70 in the forward route of the swing operation.

In the processing of step S3, if it is determined that the fixing section 70 has completed one reciprocating movement of the swing operation, the controller 100 will issue a moving distance change command (step S4). In other words, in the present embodiment, the predetermined timing for changing the moving distance of the fixing section 70 is set to the time when the fixing section 70 has completed one reciprocating movement of the swing operation.

In the processing of step S4, the controller 100 changes the initial moving distance of the fixing section 70 for the next reciprocating operation (i.e., swing operation) to a variable moving distance d2, which is different from the normal moving distance d1 (see FIG. 6). Thus, the edge of the sheet S will contact the lower fixing roller 72 and fixing belt 74 of the fixing section 70 in a portion deviated from the portion where the edge of the sheet S contacted the lower fixing roller 72 and fixing belt 74 in the last reciprocating movement (i.e., the first reciprocating movement) of the swing operation.

Thus, in the swing operation of the fixing section 70, it is possible to avoid the case where the edge of the sheet S periodically passes through the same portion of the lower fixing roller 72 and the fixing belt 74. As a result, damage to the lower fixing roller 72 and the fixing belt 74 caused by the edge of the sheet S can be reduced.

Further, since the damage to the lower fixing roller 72 and the fixing belt 74 is reduced, deterioration of the image formed on the sheet S can be suppressed, and therefore it is possible to form high-quality images.

Further, even if the space assigned for enabling the lower fixing roller 72 and fixing belt 74 to contact the edge of the sheet S is reduced, the durability of the lower fixing roller 72 and the fixing belt 74 can be maintained. As a result, the swinging distance of the fixing section 70 can be reduced, and therefore the size of the apparatus can be reduced.

In the present embodiment, since the resist mechanism 29 is arranged on the upstream side of the secondary transfer section 60 in the conveying direction of the sheet S, the position of the sheet S to be conveyed to the fixing section 70 is accurately adjusted. Thus, accuracy for the edge of the sheet S to periodically pass through the same portion of the lower fixing roller 72 and the fixing belt 74 is improved. Thus, by displacing contact portion between the edge of the sheet S (which is passing through the fixing section 70) and the lower fixing roller 72 and fixing belt 74 with the variable moving distance d2, the damage to the lower fixing roller 72 and the fixing belt 74 can be effectively reduced.

Next, the controller 100 determines whether or not the fixing processing has been completed (step S5). If it is determined that the fixing processing has not been completed, the controller 100 will move the process to step S1. Thus, the controller 100 keeps causing the fixing section 70 to move at an interval of the preset normal moving distance d1.

As described above, in the processing of step S4, the initial moving distance of the fixing section 70 for the next reciprocating operation (i.e., swing operation) is changed to the variable moving distance d2. Thus, after the fixing section 70 has been moved by the variable moving distance d2, even if the moving distance of the fixing section 70 is changed back to the normal moving distance d1, the edge of the sheet S passing through the fixing section 70 will not periodically pass through the same portion of the lower fixing roller 72 and the fixing belt 74 (see FIG. 6).

In the processing of step S5, if it is determined that the fixing processing has been completed, the controller 100 will terminate the swing operation processing.

In the present embodiment, the variable moving distance d2 is set to a value larger than the normal moving distance d1 (i.e., d1<d2). However, the variable moving distance of the present invention may also be smaller than the normal moving distance, but can not be equal to the normal moving distance.

Further, the value of the variable moving distance varies every time the fixing section 70 completes one reciprocating movement of the swing operation. To serve this purpose, for example, a counter for counting the number of the reciprocating movements of the fixing section 70 may be provided, and the value of the variable moving distance is determined according to the counted value.

### 2. Image Forming Apparatus According to Second Embodiment

### [Configuration Example of Image Forming Apparatus]

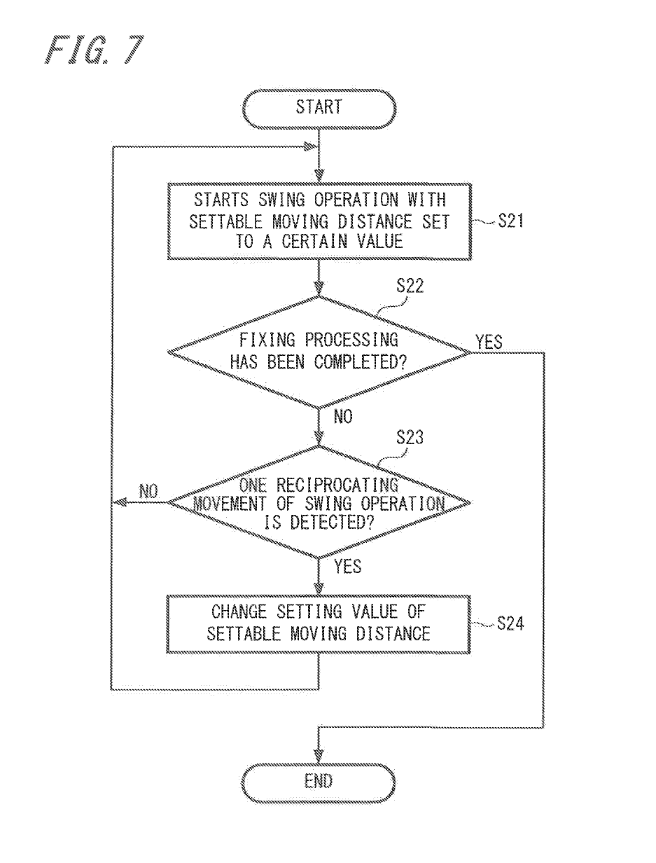

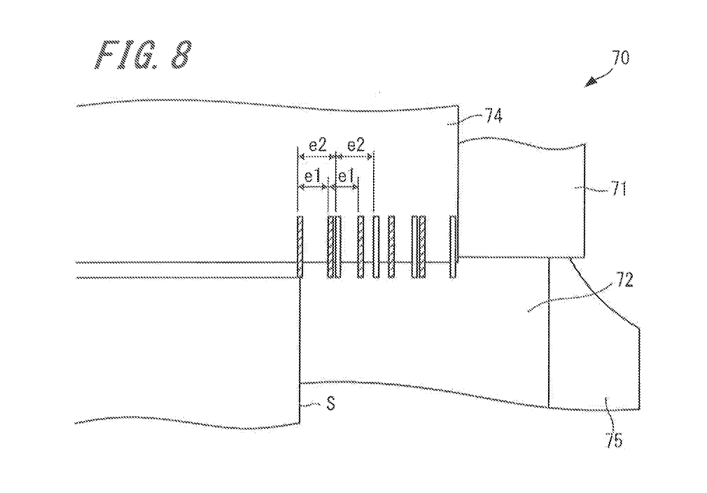

Next, an image forming apparatus according to a second embodiment of the present invention will be described below with reference to FIGS. 7 and 8.

FIG. 7 is a flowchart showing an example of the swing operation processing of the image forming apparatus according to the second embodiment. FIG. 8 is a view showing the contact portion between the edge of the sheet S and the fixing section in the case where the fixing section is in a second reciprocating movement of the swing operation.

The image forming apparatus of the second embodiment has the same configuration as that of the image forming apparatus 1 (see FIG. 1) of the first embodiment. The difference between the image forming apparatus of the second embodiment and the image forming apparatus 1 of the first embodiment is the swing operation processing of the fixing section. Thus, hereinafter, the swing operation processing of the fixing section of the image forming apparatus of the second embodiment will be described.

### [Swing Operation, Processing of Fixing Section]

The swinging operation processing of the image forming apparatus according to the second embodiment is started based on the start of the operation of forming image on the sheet S performed by the image forming section 40 (see FIG. 1). As shown in FIG. 7, when the swing operation processing is started, first, the controller 100 (see FIG. 3) starts a swing operation with a settable moving distance (step S21), wherein the settable moving distance is set to a certain value. In the swing operation, the fixing section 70 is moved by the currently set settable moving distance during the period when the sheet S has not yet entered the fixing section 70. In the present embodiment, the settable moving distance for the first reciprocating movement (i.e., the first cycle) of the swing operation of the fixing section 70 is set to “e1”.

When the processing of step S21 has been performed, the contact portion between the edge of the sheet S and the lower fixing roller 72 and fixing belt 74 of the fixing section 70 will be displaced at an interval of the settable moving distance e1 (see FIG. 8).

Thereafter, the controller 100 determines whether or not the fixing processing has been completed (step S22). If it is determined that the fixing processing has been completed, the controller 100 will terminate the swing operation processing.

In the processing of step S22, if it is determined that the fixing processing has not been completed, the controller 100 will determine whether the fixing section 70 has completed one reciprocating movement of the swing operation (step S23). The method of detecting the fact that the fixing section 70 has completed one reciprocating movement of the swing operation is identical to that of the first embodiment.

In the processing of step S23, if it is determined that the fixing section 70 has not completed one reciprocating movement of the swing operation, the controller 100 will move the process to step S21. In other words, the swing operation of the fixing section 70 with the settable moving distance e1 will continue until the fixing section 70 has completed one reciprocating movement of the swing operation. Similar to the first embodiment, in the present embodiment, when the fixing section 70 moves along the return route of the swing operation, the edge of the sheet S will contact again the same portion where the edge of the sheet S contacted the lower fixing roller 72 and fixing belt 74 of the fixing section 70 in the forward route of the swing operation.

In the processing of step S23, if it is determined that the fixing section 70 has completed one reciprocating movement of the swing operation, the controller 100 will change the setting value of the settable moving distance (step S24). In other words, in the present embodiment, the predetermined timing for changing the moving distance of the fixing section 70 is set to the time when the fixing section 70 has completed one reciprocating movement of (i.e., one cycle of) the swing operation.

In the processing of step S24, the controller 100 changes the moving distance of the fixing section 70 for the next reciprocating operation (i.e., swing operation) to a settable moving distance e2, which is different from the settable moving distance e1 (see FIG. 8). Thus, in the second reciprocating movement of the swing operation, the edge of the sheet S will contact the lower fixing roller 72 and fixing belt 74 of the fixing section 70 in a portion different from the portion where the edge of the sheet S contacted the lower fixing roller 72 and fixing belt 74 in the last reciprocating movement (i.e., the first reciprocating movement) of the swing operation.

Incidentally, it is preferred that there is no common multiple of the settable moving distance e1 and the settable moving distance e2 within the range of the swing operation. Thus, it is possible to reliably avoid the case where the edge of the sheet S contacts the same portion between the first reciprocating movement and the second reciprocating movement of the fixing section 70. As a result, damage to the lower fixing roller 72 and the fixing belt 74 caused by the edge of the sheet S can be reduced.

Similar to the first embodiment, the present embodiment is effective to be applied to an image forming apparatus having the resist mechanism 29. Further, in the present embodiment, deterioration of the image formed on the sheet S can also be suppressed, and therefore it is possible to form high-quality images. Further, even if the space assigned for enabling the fixing section 70 to contact the edge of the sheet S is reduced, the swinging distance of the fixing section 70 and the size of the apparatus can be reduced.

In the present embodiment, the settable moving distance e2 of the second reciprocating movement is set to a value larger than the settable moving distance e1 of the first reciprocating movement (i.e., e1<e2). However, the settable moving distance of the present invention may also be set in other manner as long as the settable moving distance is changed for each cycle of the swing operation of the fixing section; for example, the settable moving distance e2 may also be set to a value smaller than the settable moving distance e1 (i.e., e1>e2).

To change the value of the settable moving distance for each cycle of the swing operation of the fixing section 70, for example, a counter for counting the number of the reciprocating movements of the fixing section 70 may be provided, and the value of the settable moving distance is determined according to the counted value.

### 3. Image Forming Apparatus According to Third Embodiment

### [Configuration Example of Image Forming Apparatus]

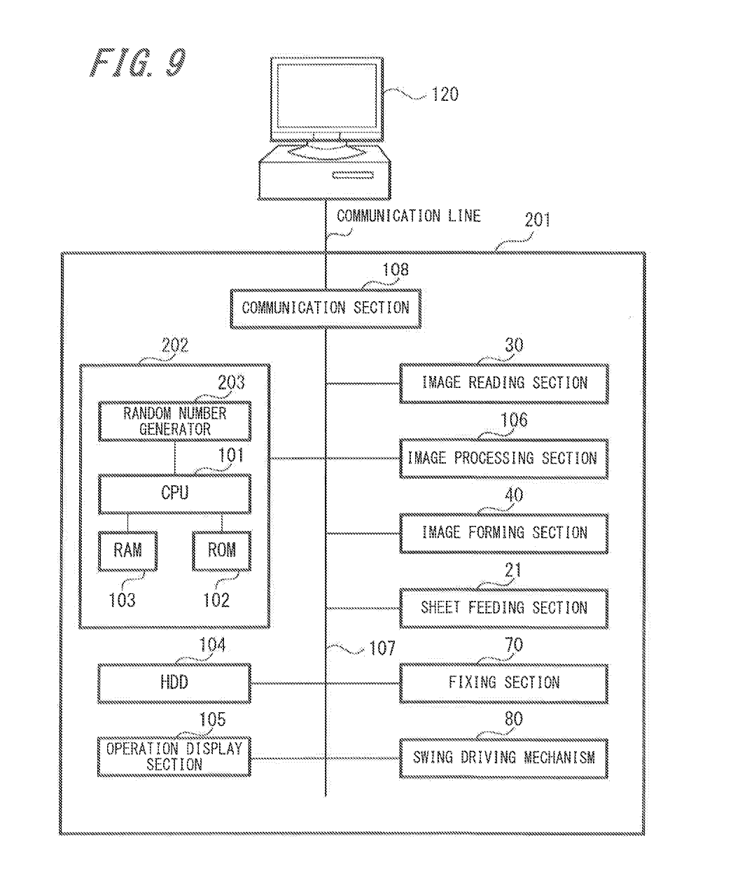

Next, an image forming apparatus 201 according to a third embodiment of the present invention will be described below with reference to FIG. 9.

FIG. 9 is a block diagram showing a control system of the image forming apparatus 201 of the third embodiment.

As shown in FIG. 9, the image forming apparatus 201 of the third embodiment has the same configuration as that of the image forming apparatus 1 (see FIG. 1) of the first embodiment. The image forming apparatus 201 differs from the image forming apparatus 1 in that the image forming apparatus 201 has a different controller 202, and different swing operation processing of fixing section controlled by the controller 202. Thus, hereinafter, the controller 202 and the swing operation processing of the fixing section will be described.

The controller 202 includes a CPU 101, a ROM 102, a RAM 103, and a random number generator 203. The random number generator 203 is adapted to generate a random number in a preset range (i.e., a range corresponding to the swinging distance of the fixing section 70). The random number generated by the random number generator 203 is extracted by, for example, a sampling circuit (not shown), and sent to the CPU 101. Based on the random number, the CPU 101 determines a moving distance X of the swing operation of the fixing section 70. Based on the determined moving distance X, the controller 202 (which includes the CPU 101) drive-controls the swing driving mechanism 80 to cause the fixing section 70 to move by the moving distance X.

### [Swing Operation Processing of Fixing Section]

The swing operation processing of the image forming apparatus 201 is started based on the start of the operation of forming image on the sheet S performed by the image forming section 40. In the swing operation processing of the fixing section, the fixing section 70 is moved by a preset moving distance during the period when the sheet S has not yet entered the fixing section 70.

The controller 202 sets a moving distance X of the fixing section 70 for each sheet S conveyed to the fixing section 70, and performs swing operation with the moving distance X. In other words, in the present embodiment, the predetermined timing for changing the moving distance of the fixing section 70 is set to the time when a predetermined number of sheets (in the present example, the predetermined number is one) have passed through the fixing section 70. The moving distance X of the fixing section 70 is set using the random number generator 203.

In the present embodiment, since the moving distance X of the fixing section 70 is set using the random number generator 203 for each sheet S conveyed to the fixing section 70, the portion where the edge of the sheet S contacts the lower fixing roller 72 and fixing belt 74 of the fixing section 70 will randomly change every time the sheet S is conveyed.

Thus, in the swing operation of the fixing section 70, it is possible to avoid the case where the edge of the sheet S passing through the fixing section 70 periodically passes through the same portion of the lower fixing roller 72 and the fixing belt 74. As a result, damage to the lower fixing roller 72 and the fixing belt 74 caused by the edge of the sheet S can be reduced.

Similar to the first and second embodiments, the present embodiment is effective to be applied to an image forming apparatus having the resist mechanism 29. Further, in the present embodiment, deterioration of the image formed on the sheet S can also be suppressed, and therefore it is possible to form high-quality images. Further, even if the space assigned for enabling the fixing section 70 to contact the edge of the sheet S is reduced, the swinging distance of the fixing section 70 and the size of the apparatus can be reduced.

### 4. Modifications

The first to third embodiments of the image forming apparatus, and the advantages thereof have been described above. It is to be understood that the image forming apparatus of the present invention is not limited to the first to third embodiments described above, and various modifications can be made without departing from the spirit and scope of the present invention.

For example, in the first and second embodiments, the predetermined timing for changing the moving distance of the fixing section 70 is set to the time when the fixing section 70 has completed one reciprocating movement of (i.e., one cycle of) the swing operation. Further, in the third embodiment, the predetermined timing for changing the moving distance of the fixing section 70 is set to the time when a predetermined number of sheets have passed through the fixing section 70.

However, the predetermined timing for changing the moving distance of the fixing section of the present invention may be suitably set. For example, the predetermined timing for changing the moving distance of the fixing section of the present invention, may be set to the time when the moving direction of the fixing section in the swing operation reverses, or the time when the fixing section has completes a plurality of cycles (i.e., a plurality of reciprocating movements) of swing operation. Further, the predetermined timing may also be the time when the job information changes (i.e., the moving distance of the fixing section may also be changed for each job information), or the time when the driving of the swing driving mechanism 80 has exceeded a predetermined time.

Further, the present invention also includes a possible configuration in which the predetermined timing for changing the moving distance of the fixing section 70 can be selected by the user according to the conditions of use of the image forming apparatus. For example, in the case where input frequency of job information is low and the number of the sheets S on which an image is to be formed is large, it will be preferred that the moving distance of the fixing section is changed at the time when the moving direction of the fixing section 70 reverses, or the time when the fixing section 70 has completes a predetermined number of cycles of swing operation.

In the case where the moving distance of the fixing section 70 is changed for each job information, if it is determined, based on the job information, that the number of the sheets S on which an image is to be formed exceeds a predetermined value, the moving distance of the fixing section 70 will be changed during the image forming operation based on the job information. Thus, it is possible to avoid the case where the edge of the sheet S periodically passes through the same portion of the lower fixing roller 72 and the fixing belt 74. As a result, damage to the lower fixing roller 72 and the fixing belt 74 caused by the edge of the sheet S can be reduced.

Further, in the first to third embodiments, the eccentric cam 833 and the stepping motor 831 for rotating the eccentric cam 833 are used as the drive section 83 of the swing driving mechanism 80. However, other driving structures for swinging the fixing section 70 may also be used as the drive section of the swing driving mechanism. Examples of the driving structures include a structure using a motor and a ball screw, a timing belt, a structure using a drive pulley and a motor, and the like.

Further, in the third embodiment, the random number generator 203 is used to determine the moving distance X of the fixing section 70. However, the moving distance of the fixing section 70 of the present invention may also be determined by using, for example, a look-up table stored in the ROM 102.

What is claimed is:

1. An image forming apparatus comprising:
a transfer section adapted to transfer toner to a sheet;
a fixing section adapted to fix the toner transferred by the transfer section to the sheet;
a swing driving mechanism adapted to perform a swing operation to move the fixing section in a direction parallel to the plane of the sheet and perpendicular to a conveying direction of the sheet; and
a controller adapted to control the driving of the swing driving mechanism to move the fixing section during the period when the sheet has not yet entered the fixing section, and cause the fixing section to move a plurality of times to thereby constitute one cycle of the swing operation of the fixing section,
wherein the controller changes the moving distance of the fixing section at a predetermined timing.

2. The image forming apparatus according to claim 1, wherein the controller causes the fixing section to move by a normal moving distance that is set to a moving distance of a certain value, and causes the fixing section to move at least once at the predetermined timing by a variable moving distance that is a moving distance different from the normal moving distance.

3. The image forming apparatus according to claim 1, wherein the controller causes the fixing section to move by a settable moving distance that is set to a moving distance of a certain value, and changes the settable moving distance at the predetermined timing.

4. The image forming apparatus according to claim 2, wherein the predetermined timing is the time when the moving direction of the fixing section reverses.

5. The image forming apparatus according to claim 2, wherein the predetermined timing is the time when the fixing section has completes one cycle or a plurality of cycles of swing operation.

6. The image forming apparatus according to claim 2, wherein the predetermined timing is the time when a predetermined number of sheets have passed through the fixing section.

7. The image forming apparatus according to claim 2, wherein the predetermined timing is the time when job information changes, the job information including information on the number of sheets to be used.

8. The image forming apparatus according to claim 7, wherein if it is determined, based on the job information, that the number of sheets S to be used exceeds a predetermined value, the predetermined timing will be changed.

9. The image forming apparatus according to claim 1, wherein the controller determines the moving distance of the fixing section using random number.

10. The image forming apparatus according to claim 9, wherein the predetermined timing is set in a period from the time when one sheet has passed through the fixing section to the time when the next sheet enters the fixing section.

11. The image forming apparatus according to claim 1, further comprising a resist mechanism disposed on the upstream side of the transfer section in the conveying direction of the sheet and adapted to adjust the position of the sheet.
